(19) United States
(12) Patent Application Publication
(10) Pub. No.: US 2012/0127635 A1
(43) Pub. Date: May 24, 2012

(54) Modular Pump Control Panel Assembly

(76) Inventor: Bruce William Grindeland, Franklin, WI (US)

(21) Appl. No.: 12/949,778

(22) Filed: Nov. 18, 2010

(51) Int. Cl. H02B 1/00

(52) U.S. Cl. 361/605

(57) ABSTRACT

A modular pump control panel assembly consisting of multiple compartments arranged so as to allow service of each individual compartment without exposure to line voltages while still maintaining operation of the pumping system. The assembly includes a plurality of motor controller compartments each including a lockable handle operator that that is interlocked with its corresponding compartment door. The handle operators are mechanically connected to remote disconnecting devices via flexible cables or mechanical linkage. A key feature/distinction of this invention is that the disconnecting devices are not located in their corresponding motor controller compartments, so that when the handle operator is switched to the OFF position there are no components (e.g. disconnecting device and/or its supply conductors) within the motor controller compartment that remains energized by line voltage.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to pump control systems, and more particularly, to those pump control systems used to control multiple pumps such as are used in duplex and triplex pumping systems.

Herein, we use “low-voltage” to mean less than 50 volts. We refer to “line-voltage” as greater than 50 volts, and 120V is used to mean a specific nominal line-voltage that is lower than the line-voltage used to power the pumps. The line voltage used to power the pumps is typically 480 volt, 3-phase or 240 volt 3-phase. The 120V circuits are typically used for functions such as powering low-voltage supplies, starter coils, interposing relays, and the like.

Commonly, all components of such a system are installed in a single enclosure. Such an arrangement necessitates de-energizing the entire enclosure for service or adjustment of a single component when following safety procedures and regulations. Federal safety regulations require de-energizing enclosures containing voltages of 50 volts and higher except in specific exceptional situations. De-energizing the entire enclosure is problematic in those applications that require operation of at least one of the controlled pumps at any time.

Another common method used in such pump control systems is to utilize motor control centers that compartmentalize motor controllers in removable subunits. Motor control center subunits typically have the disconnecting device (e.g. circuit breaker) enclosed within the subunit itself; which means the subunit must still be considered energized due to the fact that the disconnecting device and conductors feeding it are still energized and within the enclosure even after the door interlocked handle is switched to the OFF position. Thus, the subunit is not totally de-energized even when the disconnect handle is in the OFF position. In order to completely de-energize a motor control center subunit for service the subunit stabs must be disconnected from the motor control center bus. Safety hazards including arc-flash exist when disconnecting stabs from a live bus. Powering down the motor control center is problematic in applications where operation of at least one motor or other load served by the motor control center system is required during maintenance.

It would therefore be desirable to design a pump control system that allows one or more of the controlled pumps to remain in operation while components within the system are serviced within a compartment that is totally de-energized.

### BRIEF SUMMARY OF THE INVENTION

A modular pump control panel assembly consisting of multiple compartments arranged so as to allow service of each individual compartment without exposure to line voltages while still maintaining operation of the pumping system. The assembly includes a plurality of motor controller compartments each including a lockable handle operator that that is interlocked with its corresponding compartment door. The handle operators are mechanically connected to remote disconnecting devices (e.g. circuit breakers or the like) via flexible cables or mechanical linkage. A key feature and distinction of this invention is that the disconnecting devices are not located in their corresponding motor controller compartments, even though the handle that operates the disconnecting device is a part of the motor controller compartment and interlocks with the door of same. Thus, when the handle operator is switched to the OFF position, access is granted to the motor controller compartment which in this state now contains no components (i.e. not even the disconnecting device and/or its supply conductors) energized by line voltage. The assembly is constructed of an overall enclosure housing that contains within it a plurality of motor controller compartments, one or more compartments for remote mounted disconnecting devices, and additional separate compartments as required for devices such as low-voltage controllers, power transfer switches, and termination compartments for field wiring connections.

### BRIEF DESCRIPTION OF THE SEVERAL VIEWS OF THE DRAWING

The Drawings demonstrate one solution for a preferred embodiment of the described invention.

Displayed in the drawings:

FIG. 1 is a front elevation view of the modular compartments within an overall enclosure. The doors of the overall enclosure, as well as the modular compartments, are closed in FIG. 1.

FIG. 2 is a front elevation view of the modular compartments within an overall enclosure. The termination compartment doors of the overall enclosure, the doors for the motor controller compartments and the plate/door for the breaker compartment are removed in FIG. 2. The motor controller compartment doors are not shown. The flexible cables linking the door handle operators to the remote disconnects are shown diagrammatically.

### DETAILED DESCRIPTION OF THE INVENTION

The following description makes reference to line voltage, low voltage, and the like. It is appreciated that such terms may refer to a variety of both common voltage ranges and unique voltages depending on context. However, it is appreciated that the present invention is intended for use in typical pumping system control applications and the purpose of the invention is to simplify compliance with safety regulations and procedures while keeping the pumping system in operation during such maintenance. In this context, we refer to voltages below 50 volts as “low voltage” because regulations allow access to energized control panels when only voltages below 50 exist within. We refer herein to the pump motor supply voltage as well as any other associated circuits of 50 volts or higher as “line voltage”. A typical example would consist of a system wherein the pump motors are supplied at 480 volts 3-phase, starter coils and relays and associated with the motor controllers are supplied at 120 volts 1-phase, and control system components such as programmable logic controllers and modems are supplied at 24 volts DC.

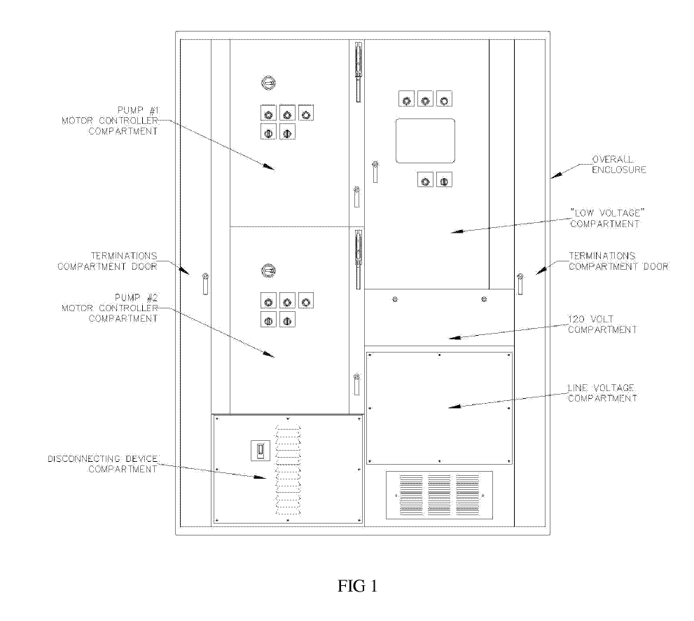

Referring to FIG. 1 a front elevation view of an embodiment of the invention is shown. The overall enclosure contains within it components of a typical duplex pump control system as commonly used applications such as sewage lift stations and water booster pumping stations. Components include motor controllers which may be full-voltage starters, solid-state-reduced-voltage starters, or variable frequency drives.

The general appearance of the invention is similar to that of a motor control center in that it contains multiple separate compartments, some of which include disconnect operating handles interlocked with the compartment doors. However, there are important and distinct differences between the present invention and existing motor control center designs.

Buckets for motor control centers are supplied with power via stabs that connect to bus bars. Energized conductors enter the bucket and connect to the supply side of the bucket disconnecting device. The bucket includes a handle operator that interlocks with disconnecting device (e.g. circuit breaker) that is located within the bucket. When the handle is moved to the OFF position a door interlock allows access to the bucket. A hazard exists in that the compartment, which the door interlock has granted access to, contains parts energized at line voltage even when the handle is in the OFF position. Safety procedures and regulations do not allow working within a compartment that contains parts energized at 50 volts or higher other than specific exceptional situations. Removing motor control center buckets and disconnecting the stabs presents new hazards of arc-flash if performed when the bus is energized. De-energizing the motor control center is often undesirable because many load devices may be fed from the motor control center and shutting down all loads can; disrupt the process, cause flooding in the case of a sewage lift station, or cause loss of water pressure in the case of a water booster station.

The motor controller compartments of the present invention are distinctly different from existing; there are three ways in which they are different that I will expound upon.

The first distinction is that in the preferred embodiment of my invention the disconnecting device is remotely located, while still operated by the handle operator that is part of the motor controller compartment and interlocked with the motor controller compartment door. This feature eliminates the existence of energized line voltage parts within the compartment when the handle is switched to the OFF position. The incoming power conductors come from the load side of the remote disconnect only; so the supply conductors are de-energized in OFF position as well.

Secondly, in the preferred embodiment of my invention; there is no use of stabs (e.g. those that are commonly used to connect line voltage for disconnecting devices to bus bars). By not making use of stabs; the risks that are associated with them (e.g. arc-flash between phases when removing the bucket) are no longer present. Also, there is not need to worry about the integrity of the connection between the bus bars and the stabs decaying over time due to connection and disconnection.

Thirdly; whereas in some cases with motor control centers a person would be exposed to bus bars when the bucket or sub-panel was removed, in the preferred embodiment of my invention; behind the sub-panel is the back of the enclosure for which the person is servicing. In the preferred embodiment of my invention; the interior of each compartment is isolated from that of any of the other compartments within the system.

Another very common conventional design for pump control panels used in smaller sewage lift stations and water booster stations is to install all motor controllers, breakers, transformers, relays, logic controllers, telemetry equipment, and other devices within a single enclosure. This design makes adherence to electrical safety regulations extremely inconvenient in that one would need to de-energize the entire control panel for many common maintenance tasks. As it is often undesirable to shut down the pumping process, and as it is inconvenient to follow all applicable safety regulations in this case, personnel may tend to ignore regulations and access the panel energized when performing common maintenance tasks.

It is a purpose of my invention to simplify compliance with safety regulations, thereby encouraging compliance.

Referring again to FIG. 1, assume it is necessary to perform maintenance to the motor controller serving pump #1 of a duplex system. The technician switches the pump #1 motor controller compartment handle to the OFF position. Following standard safety procedures the technician then verifies that the pump #1 compartment is de-energized and locks out and tags out the handle. At this point he can perform his work within the compartment without concern of violating regulations as the compartment he is working in is completely de-energized of line voltage. While performing his work the pumping control system continues to operate automatically using pump #2. This scenario is preferable to de-energizing the entire system as would be required with the commonly used single panel design described above. It is also preferable to working in a motor control center bucket that contains live line side lugs and supply conductors even when the disconnect handle is locked in the OFF position.

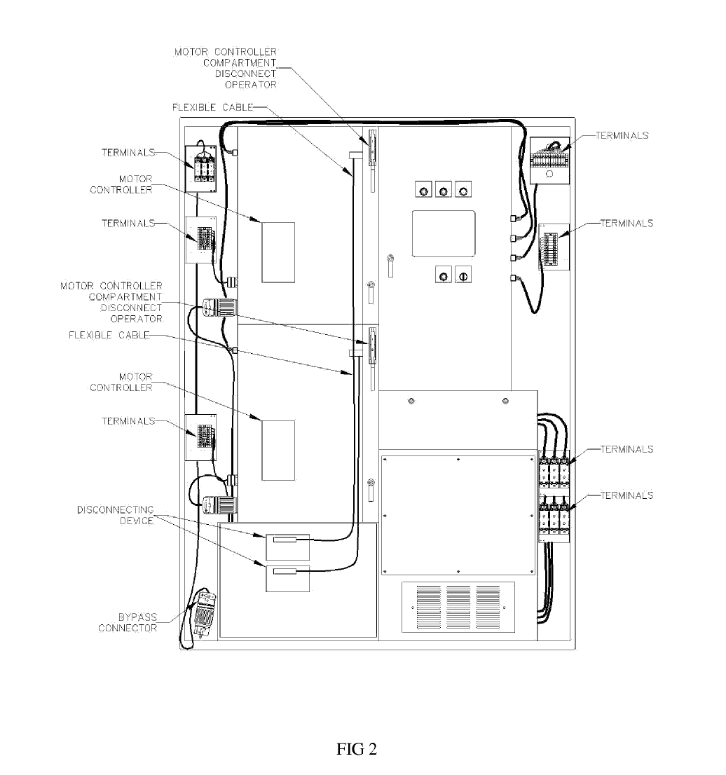

Referring to FIG. 2, we see an internal representation of the disconnecting devices located in a compartment separate from the motor controller compartments. These disconnecting devices may also require maintenance. In my preferred embodiment the compartment(s) housing these disconnecting devices can be de-energized without interrupting the pumping process. An alternate power source can be provided. This alternate source can be the same utility power providing normal power, but provided from a separate breaker or fused switch and connected to the bypass power terminals. A bypass power connector being fed from the bypass power terminals can be plugged into either of the motor controller compartments;

One of the motor controller compartments would be de-energized by putting the disconnect handle in the OFF position.

The bypass power plug would then replace the normal power plug.

The normal supply power serving the control panel would then be de-energized and an alternate supply energized as the bypass feed (in this state; the disconnecting device compartment as well as the line voltage compartment are totally de-energized for maintenance, the pumping system continues to operate using the pump(s) supplied with bypass power).

Referring to FIG. 1, in my preferred embodiment a separate line voltage compartment is provided for incoming power provisions and equipment such as automatic transfer switch, surge protection, and the like. This compartment provides power to the disconnecting devices in the disconnecting device compartment(s) and is served by connection lugs in the termination compartments. This line voltage compartment may be bypassed as described above for maintenance.

Referring to FIG. 1, in my preferred embodiment a separate low voltage compartment is provided for automatic control devices such as programmable logic controllers, telemetry equipment, and the like. All devices and wiring in this compartment should be powered at less than 50 volts so that the automatic controls can be serviced while energized when necessary. A DC battery backup system located within the low voltage compartment can be used to power the automatic controls, telemetry, and field devices (e.g. pressure or level sensors) so that automatic operation and monitoring are available even when normal power is de-energized and a pump is being operated on bypass power.

Referring to FIG. 1, in my preferred embodiment a separate 120 volt compartment is provided for devices such as DC power supplies and circuit breakers for 120 VAC loads. The DC supplies are located herein rather than in the low voltage compartment as the DC supplies typically are energized at 120 VAC on their input terminal Placing the DC supplies external to the low voltage compartment allows the low voltage compartment to be serviced in an energized state.

Referring to FIG. 1, in my preferred embodiment the various compartments described previously are assembled into an overall enclosure. The overall enclosure provides areas for field terminations and wire routing. It is preferred that interconnections between the various compartments enter each compartment via “thru-wall” terminals and plugs as shown in FIG. 2 such that the integrity of separation between compartments is not compromised by openings.

To manufacture my invention:

The manufacturing entity would mount and wire the appropriate devices for each of the following aspects of pumping control within their respective compartments, while following the necessary guidelines that I have previously laid out within this document (e.g. mounting motor controller disconnects in separate compartments from the motor controllers which they feed so that line voltage is removed entirely from the motor controller compartment when the disconnect and its respective handle are in the OFF position, mounting power-supplies that require a supply voltage greater than 50 volts in a separate compartment from the controls which they supply power to, and the like).
Motor Controllers
Disconnecting Devices
AUTO Logic Controls (e.g. PLC(s), relays, and the like)
Other Devices, as necessary (e.g. transfer switches, circuit breakers, surge protection devices, and the like)

Components and methods such as; through-wall terminals, interlocking handles, interposing relays, indicators or operators with appropriate gaskets, and the like should be used so that the integrity of isolating the compartments, from each other and a person standing in front of the system, remains in tact.

The compartments should be arranged in such a way to allow for operation and interaction of the complete system in the mode that I have described within this document.

In the preferred embodiment of my invention; all of the individual compartments would be arranged and mounted within an overall enclosure.

When manufacturing in volume, a complete single enclosure which includes all of the same separation by barriers and various doors and covers could be made to reduce costs and materials used for a specific configuration.

In smaller volumes use of separate enclosures installed within an overall housing is more flexible, in that various options can be pre-assembled in compartment enclosures and then assembled in different combinations for project specific requirements. For example, a triplex system could be generally the same as the duplex system shown in the figures except that three smaller motor controller compartments would be installed in the same space that is used for two motor control compartments as depicted in FIG. 1 and FIG. 2.

I have herein described the preferred embodiment of the present invention in one form that would be useful for a duplex pumping control system. The specific arrangement would necessarily vary depending on the number of pumps, project specific requirements, and desired optional features. It is recognized that equivalents, alternatives, and modifications, aside from those expressly stated, are possible and within the scope of the appending claims.

### DRAWINGS

Drawings are contained in file Drawings.pdf

### OATH OR DECLARATION

Declaration is contained within file Declaration.pdf

### SEQUENCE LISTING

Not Applicable

What I claim as my invention is:

1. A modular pump control panel assembly consisting of multiple compartments arranged so as to allow service of individual compartments without exposure to line voltages while still maintaining operation of the pumping system.

2. The modular pump control panel of claim 1 wherein disconnecting devices (e.g. circuit breakers) are compartmentalized separately from the motor controller compartments that they provide power to, so as to have no line voltages present in the motor controller compartment when disconnecting device is open.

3. The modular pump control panel of claim 1 wherein each motor controller compartment disconnect handle interlocks with its corresponding motor controller compartment door to prevent access to the motor controller compartment when the corresponding handle is in the ON position, as the motor controller compartment is energized by the remotely mounted disconnecting device in this state.

4. The modular pump control panel of claim 1 wherein each motor controller compartment disconnect handle interlocks with its corresponding motor controller compartment door to grant access to the motor controller compartment when the handle is in the OFF position, as the motor controller compartment is de-energized by the remotely mounted disconnecting device in this state.

5. The modular pump control panel of claim 1 wherein each motor controller compartment disconnect handle operates a disconnecting device that is remotely located in a compartment separate from the motor controller compartment that the disconnect handle is a part of.

6. The modular pump control panel of claim 1 wherein the modular compartments are contained within an overall enclosure.

7. The modular pump control panel of claim 1 further comprising bypass power connections to allow for an alternate route of power supplied to a motor controller compartment(s).

8. In reference to claim 7, the bypass power is routed such that it does not pass through the disconnect compartment thus allowing servicing of the disconnect compartment in a de-energized state while maintaining operation of the motor controller(s).

9. The modular pump control panel of claim 1 further comprising a separate compartment containing incoming power provisions such as power transfer switch, surge suppressors, and the like.

10. The modular pump control panel of claim 1 further comprising a separate compartment containing 120 VAC devices such as branch circuit breakers, low-voltage power supplies for low-voltage loads, and the like.

11. The modular pump control panel of claim 1 further comprising a separate compartment containing only low-voltage wiring and devices and such as programmable controllers, telemetry devices, relays and the like.
